(19) United States
(12) Patent Application Publication
(10) Pub. No.: US 2026/0151944 A1
(43) Pub. Date: Jun. 4, 2026

(54) INJECTION MOLDING MACHINE

(71) Applicant: SUMITOMO HEAVY INDUSTRIES, LTD., Tokyo (JP)

(72) Inventors: Koki INOUE, Chiba (JP); Kiminori SAKAI, Chiba (JP); Shogo MAEGAWA, Chiba (JP); Naoki KAMIO, Chiba (JP)

(21) Appl. No.: 19/286,953

(22) Filed: Jul. 31, 2025

(30) Foreign Application Priority Data
Dec. 4, 2024 (JP) 2024-211157

(51) Int. Cl. B29C 45/68; B29C 45/03

(52) U.S. Cl. CPC B29C 45/68; B29C 45/03; B29C 2045/686; B29C 2945/76391; B29C 2945/76481

(57) ABSTRACT

An injection molding machine includes a ball screw configured to convert a rotational motion of a motor into a linear motion of a crosshead, a toggle mechanism including the crosshead and a pair of link groups that are bent and extended by the crosshead moving frontward and rearward, a toggle support including a pair of attachment portions to which the link groups of the pair of link groups are respectively attached, and a strain gauge configured to detect a strain of the toggle support. The toggle support includes a pair of guides configured to guide the crosshead, a pair of arms configured to support the pair of guides, and a platen having one surface on which the pair of attachment portions and the pair of arms are provided.

### CROSS-REFERENCE TO RELATED APPLICATIONS

This application claims priority to Japanese Patent Application No. 2024-211157, filed Dec. 4, 2024, the entire content of which is incorporated herein by reference.

### BACKGROUND

### 1. Technical Field

The present invention relates to an injection molding machine.

### 2. Description of Related Art

An injection molding machine is configured to measure an amount of strain of a crosshead link constituting a toggle mechanism, obtain a difference between actually measured stresses applied to the upper and lower parts of the crosshead, and determine whether the value of the difference of actually measured stresses is a value that indicates necessity of maintenance and inspection of the toggle mechanism.

### SUMMARY

An injection molding machine according to an embodiment of the present invention includes: a ball screw configured to convert a rotational motion of a motor into a linear motion of a crosshead, a toggle mechanism including the crosshead and a pair of link groups that are bent and extended by the crosshead moving frontward and rearward, a toggle support including a pair of attachment portions to which the link groups of the pair of link groups are respectively attached, and a strain gauge configured to detect a strain of the toggle support. The toggle support includes a pair of guides configured to guide the crosshead, a pair of arms configured to support the pair of guides, and a platen having one surface on which the pair of attachment portions and the pair of arms are provided. The pair of attachment portions are provided, with a reference plane interposed between the attachment portions, the reference plane including a rotation center line of the ball screw, the pair of guides, and the pair of arms. The strain gauge is attached to the arm or the one surface of the platen.

### BRIEF DESCRIPTION OF THE DRAWINGS

FIG. 1 is a diagram illustrating a state of an injection molding machine according to an embodiment at the time of completion of mold opening;

FIG. 2 is a diagram illustrating a state of the injection molding machine according to the embodiment at the time of completion of mold clamping;

FIG. 3 is a side sectional view illustrating an example of a mold clamping device;

FIG. 4 is a plan sectional view of a toggle support illustrated in FIG. 3;

FIG. 5 is a side view of the toggle support illustrated in FIG. 3;

FIG. 6A is a perspective view illustrating an example of the toggle support;

FIG. 6B is a plan view illustrating an example of the toggle support; and

FIG. 7 is a graph illustrating an example of a detection value of a strain gauge.

### DETAILED DESCRIPTION

An injection molding machine has a ball screw that converts a rotational motion of a motor into a linear motion of a crosshead of a toggle mechanism. An occurrence of an unbalanced load on the crosshead causes an unbalanced load on the ball screw. As a result, uneven wear of the ball screw may develop.

An embodiment of the present invention provides a technique capable of detecting an unbalanced load on a ball screw of an injection molding machine.

Hereinafter, embodiments of the present invention will be described with reference to the drawings. In the drawings, the same or corresponding components are denoted by the same or corresponding reference numerals, and the description thereof may be omitted.

### Injection Molding Machine

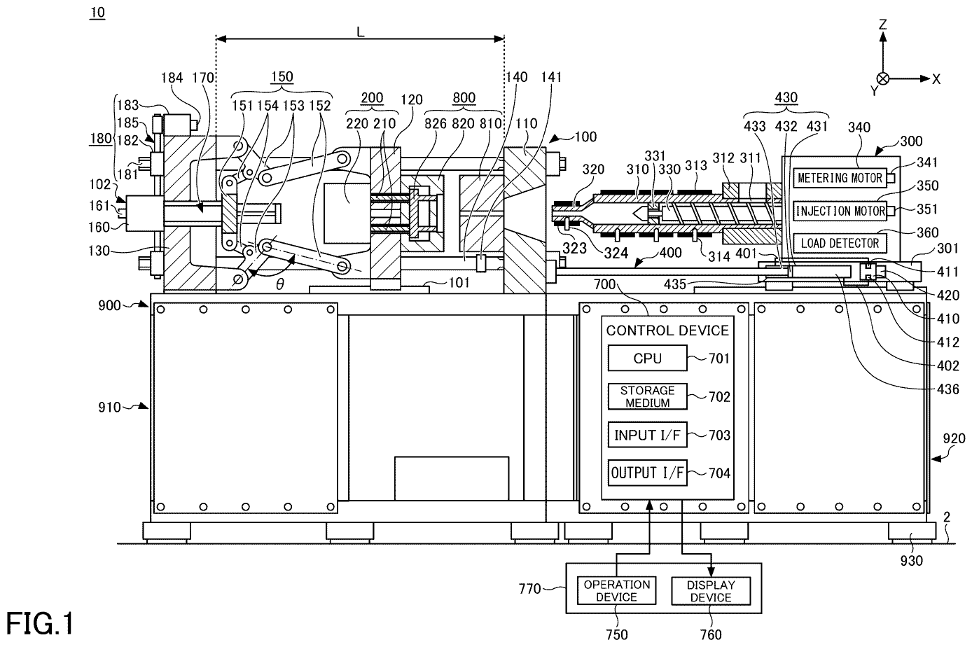

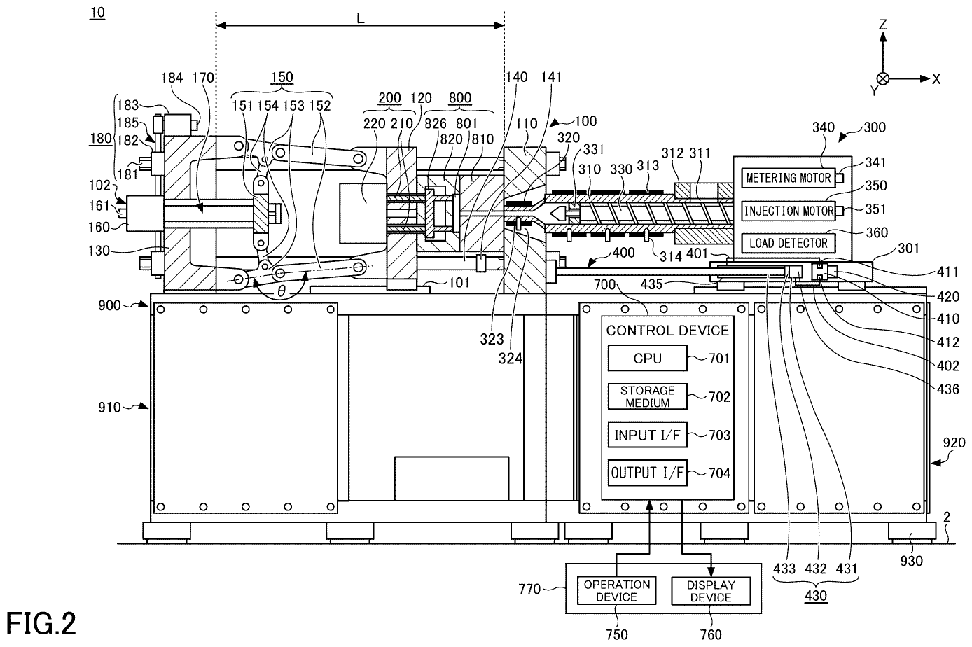

FIG. 1 is a diagram illustrating a state of an injection molding machine according to an embodiment at the time of completion of mold opening. FIG. 2 is a diagram illustrating a state of an injection molding machine according to the embodiment at the time of mold clamping. In the present specification, an X-axis direction, a Y-axis direction, and a Z-axis direction are directions perpendicular to each other. The X-axis direction and the Y-axis direction represent a horizontal direction, and the Z-axis direction represents a vertical direction. In the case where a mold clamping device 100 is a horizontal type, the X-axis direction is a mold opening/closing direction, and the Y-axis direction is a width direction of an injection molding machine 10. The negative side in the Y-axis direction is hereinafter called an “operation side”, and the positive side in the Y-axis direction is hereinafter called a “side opposite to the operation side”.

As illustrated in FIGS. 1 and 2, the injection molding machine 10 includes: a mold clamping device 100 that opens and closes the mold device 800; an ejector device 200 that ejects a molded article that is molded by the mold device 800; an injection device 300 that injects a molding material into the mold device 800; a moving device 400 that advances and retracts the injection device 300 with respect to the mold device 800; a control device 700 that controls each component of the injection molding machine 10; and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are installed on the floor 2 via leveling adjusters 930. The control device 700 is provided in the internal space of the injection device frame 920. Hereinafter, each component of the injection molding machine 10 will be described.

### Mold Clamping Device

In the description of the mold clamping device 100, a moving direction of a movable platen 120 at the time of mold closing (for example, an X-axis positive direction) is defined as the front, and a moving direction of the movable platen 120 at the time of mold opening (for example, an X-axis negative direction) is defined as the rear.

The mold clamping device 100 performs mold closing, pressure increasing, mold clamping, pressure releasing, and mold opening of the mold device 800. The mold device 800 includes a stationary mold 810 and a movable mold 820.

The mold clamping device 100 is, for example, a horizontal type, and the mold opening/closing direction is a horizontal direction. The mold clamping device 100 includes a stationary platen 110 to which the stationary mold 810 is attached, a movable platen 120 to which the movable mold 820 is attached, and a moving mechanism 102 that moves the movable platen 120 in the mold opening/closing direction with respect to the stationary platen 110.

The stationary platen 110 is fixed to the mold clamping device frame 910. A stationary mold 810 is attached to a surface of the stationary platen 110 facing the movable platen 120.

The movable platen 120 is disposed so as to be movable in the mold opening/closing direction with respect to the mold clamping device frame 910. A guide 101 for guiding the movable platen 120 is laid on the mold clamping device frame 910. The movable mold 820 is attached to a surface of the movable platen 120 facing the stationary platen 110.

The moving mechanism 102 moves the movable platen 120 frontward and rearward with respect to the stationary platen 110 to perform mold closing, pressure increasing, mold clamping, pressure releasing, and mold opening of the mold device 800. The moving mechanism 102 includes: a toggle support 130 disposed at a distance from the stationary platen 110; tie bars 140 each connecting the stationary platen 110 and the toggle support 130; a toggle mechanism 150 configured to move the movable platen 120 in the mold opening/closing direction with respect to the toggle support 130; a mold clamping motor 160 operating the toggle mechanism 150; a motion conversion mechanism 170 converting the rotational motion of the mold clamping motor 160 into linear motion; and a mold thickness adjustment mechanism 180 configured to adjust the distance between the stationary platen 110 and the toggle support 130.

The toggle support 130 is disposed apart from the stationary platen 110 and is placed on the mold clamping device frame 910 so as to be movable in the mold opening/closing direction. The toggle support 130 may be disposed so as to be movable along a guide laid on the mold clamping device frame 910. The guide of the toggle support 130 may be shared with the guide 101 of the movable platen 120.

In the present embodiment, although the stationary platen 110 is fixed to the mold clamping device frame 910, and the toggle support 130 is disposed so as to be movable in the mold opening/closing direction with respect to the mold clamping device frame 910, the toggle support 130 may be fixed to the mold clamping device frame 910, and the stationary platen 110 may be disposed so as to be movable in the mold opening/closing direction with respect to the mold clamping device frame 910.

The tie bar 140 connects the stationary platen 110 and the toggle support 130 with an interval L therebetween in the mold opening/closing direction. A plurality of (for example, four) tie bars 140 may be used. The plurality of tie bars 140 are arranged in parallel in the mold opening/closing direction and extend in accordance with a mold clamping force. At least one of the tie bars 140 is provided with a tie bar strain detector 141 for detecting strain of the tie bar 140. The tie bar strain detector 141 sends a signal indicating a result of the detection to the control device 700. The detection result of the tie bar strain detector 141 is used for detection of a mold clamping force and the like.

In the present embodiment, the tie bar strain detector 141 is used as a mold clamping force detector for detecting a mold clamping force, but the present invention is not limited thereto. The mold clamping force detector is not limited to a strain gauge type, and may be a piezoelectric type, a capacitance type, a hydraulic type, an electromagnetic type, or the like, and the attachment position thereof is not limited to the tie bar 140.

The toggle mechanism 150 is disposed between the movable platen 120 and the toggle support 130, and moves the movable platen 120 in the mold opening/closing direction with respect to the toggle support 130. The toggle mechanism 150 includes a crosshead 151 that moves in the mold opening/closing direction, and a pair of link groups that are bent and extended by the movement of the crosshead 151. The pair of link groups each include a first link 152 and a second link 153 which are connected to each other by a pin or the like so as to be bendable and extendable. The first link 152 is swingably attached to the movable platen 120 by a pin or the like. The second link 153 is swingably attached to the toggle support 130 by a pin or the like. The second link 153 is attached to the crosshead 151 via a third link 154. In response to the crosshead 151 moving frontward and rearward with respect to the toggle support 130, the first link 152 and the second link 153 are bent and extended, and the movable platen 120 is moved frontward and rearward with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. By moving the crosshead 151 frontward and rearward with respect to the toggle support 130, the mold clamping motor 160 bends and extends the first link 152 and the second link 153 and moves the movable platen 120 frontward and rearward with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing step, a pressure increasing step, a mold clamping step, a pressure releasing step, a mold opening step, and the like under the control of the control device 700.

In the mold closing step, the mold clamping motor 160 is driven to advance the crosshead 151 to a mold closing completion position at a set moving speed, thereby advancing the movable platen 120 and causing the movable mold 820 to touch the stationary mold 810. The position and the moving speed of the crosshead 151 are detected by using, for example, a mold clamping motor encoder 161. The mold clamping motor encoder 161 detects the rotation of the mold clamping motor 160 and sends a signal indicating the detection result to the control device 700.

A crosshead position detector that detects the position of the crosshead 151 and a crosshead moving speed detector that detects the moving speed of the crosshead 151 are not limited to the mold clamping motor encoder 161, and general detectors can be used. The movable platen position detector for detecting the position of the movable platen 120 and the movable platen moving speed detector for detecting the moving speed of the movable platen 120 are not limited to the mold clamping motor encoder 161, and general detectors can be used.

In the pressure increasing step, a mold clamping force is generated by further driving the mold clamping motor 160 to further advance the crosshead 151 from the mold closing completion position to a mold clamping position.

In the mold clamping step, the mold clamping motor 160 is driven to maintain the position of the crosshead 151 at the mold clamping position. In the mold clamping step, the mold clamping force generated in the pressure increasing step is maintained. In the mold clamping step, a cavity space 801 (see FIG. 2) is formed between the movable mold 820 and the stationary mold 810, and the injection device 300 fills the cavity space 801 with a liquid molding material. The filled molding material is solidified to obtain a molded article.

There may be more than one cavity space 801. In this case, a plurality of molded articles are obtained simultaneously. An insert component may be disposed in one part of the cavity space 801, and a molding material may be filled in another part of the cavity space 801. A molded article in which the insert component and the molding material are integrated is obtained.

In the pressure releasing step, the movable platen 120 is retracted by driving the mold clamping motor 160 to retract the crosshead 151 from the mold clamping position to the mold opening start position, and the mold clamping force is thus reduced. The mold opening start position and the mold closing completion position may be the same position.

In the mold opening step, the movable platen 120 is retracted by driving the mold clamping motor 160 to retract the crosshead 151 from the mold opening start position to the mold opening completion position at a set moving speed, and the movable mold 820 is separated from the stationary mold 810. Thereafter, the ejector device 200 ejects the molded product from the movable mold 820.

The set conditions for the mold closing step, the pressure increasing step, and the mold clamping step are collectively set as a series of set conditions. For example, a moving speed and a position (including a mold closing start position, a moving speed switchover position, a mold closing completion position, and a mold clamping position) of the crosshead 151 for the mold closing step and the pressure increasing step, and the mold clamping force are collectively set as a series of set conditions. A mold closing start position, a moving speed switchover position, a mold closing completion position, and a mold clamping position are arranged in this order from the rear to the front, and represent a start point and an end point of a section for which a moving speed is set. A moving speed is set for each section. The number of a moving speed switchover position may be one or more. A moving speed switchover position need not be set. Only either of a mold clamping position and a mold clamping force may be set.

The set conditions for the pressure releasing step and the mold opening step are set in the same manner. For example, a moving speed and a position (a mold opening start position, a moving speed switchover position, a mold opening completion position) of the crosshead 151 for the pressure releasing step and the mold opening step are collectively set as a series of set conditions. A mold opening start position, a moving speed switchover position, a mold opening completion position are arranged in this order from the front to the rear, and represent a start point and an end point of a section for which a moving speed is set. A moving speed is set for each section. The number of a moving speed switchover positions may be one or more. A moving speed switchover position need not be set. A mold opening start position and a mold closing completion position may be the same position. A mold opening completion position and a mold closing start position may be the same position.

Instead of a moving speed and a position of the crosshead 151, a moving speed and a position of the movable platen 120 may be set. Instead of a position of the crosshead (for example, a mold clamping position) or a position of the movable platen, a mold clamping force may be set.

The toggle mechanism 150 amplifies a driving force of the mold clamping motor 160 and transmits the amplified driving force to the movable platen 120. An amplification factor is also called a “toggle factor”. A toggle factor changes according to an angle θ formed by the first link 152 and the second link 153 (hereinafter, also referred to as a “link angle θ”). The link angle θ is obtained from the position of the crosshead 151. When the link angle θ is 180°, the toggle factor is maximized.

In the case where the thickness of the mold device 800 changes due to a replacement of the mold device 800 or a temperature change of the mold device 800, the mold thickness is adjusted so that a predetermined mold clamping force is obtained at the time of mold clamping. In the mold thickness adjustment, for example, an interval L between the stationary platen 110 and the toggle support 130 is adjusted so that the link angle θ of the toggle mechanism 150 becomes a predetermined angle at the time of the movable mold 820 touching the stationary mold 810 (or “mold touch”).

The mold clamping device 100 includes a mold thickness adjustment mechanism 180. The mold thickness adjustment mechanism 180 adjusts a mold thickness by adjusting an interval L between the stationary platen 110 and the toggle support 130. The mold thickness adjustment is performed at a timing between the end of a molding cycle and the start of a next molding cycle, for example. The mold thickness adjustment mechanism 180 includes, for example, a screw shaft 181 formed at the rear end portion of the tie bar 140, a screw nut 182 held by the toggle support 130 so as to be rotatable and not to be movable frontward and rearward, and a mold thickness adjustment motor 183 that rotates the screw nut 182 screwed to the screw shaft 181.

The screw shaft 181 and the screw nut 182 are provided for each tie bar 140. A rotational driving force of the mold thickness adjustment motor 183 may be transmitted to the plurality of screw nuts 182 via the rotational driving force transmitter 185. The plurality of screw nuts 182 can be rotated synchronously. The plurality of screw nuts 182 can be individually rotated by changing the transmission path of the rotational driving force transmitter 185.

The rotational driving force transmitter 185 is configured by, for example, a gear. In this case, a driven gear is formed on the outer periphery of each screw nut 182, a driving gear is attached to the output shaft of the mold thickness adjustment motor 183, and an intermediate gear which meshes with the plurality of driven gears and the driving gear is rotatably held at the center of the toggle support 130. The rotational driving force transmitter 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nuts 182. As a result, the position of the toggle support 130 with respect to the tie bar 140 is adjusted, and the interval L between the stationary platen 110 and the toggle support 130 is adjusted. A plurality of mold thickness adjustment mechanisms may be used in combination.

The interval L is detected by using a mold thickness adjustment motor encoder 184. The mold thickness adjustment motor encoder 184 detects a rotation amount and a rotation direction of the mold thickness adjustment motor 183 and sends a signal indicating the detection result to the control device 700. The detection result of the mold thickness adjustment motor encoder 184 is used for monitoring and controlling the position of the toggle support 130 and the interval L. The toggle support position detector for detecting the position of the toggle support 130 and the interval detector for detecting the interval L are not limited to the mold thickness adjustment motor encoder 184, and general detectors can be used.

The mold clamping device 100 may include a mold temperature regulator that controls the temperature of the mold device 800. The mold device 800 has a flow path for a temperature regulating medium therein. The mold temperature regulator controls the temperature of the mold device 800 by controlling the temperature of a temperature regulating medium supplied to the flow path of the mold device 800.

The mold clamping device 100 of the present embodiment is a horizontal type in which the mold opening/closing direction is a horizontal direction, but may be a vertical type in which the mold opening/closing direction is a vertical direction.

The mold clamping device 100 of the present embodiment includes the mold clamping motor 160 as a drive but may include a hydraulic cylinder instead of the mold clamping motor 160. The mold clamping device 100 may include a linear motor for mold opening and closing and an electromagnet for mold clamping.

### Ejector Device

In the description of the ejector device 200, similarly to the descriptions of the mold clamping device 100, a moving direction of the movable platen 120 at the time of mold closing (for example, an X-axis positive direction) is defined as the front, and a moving direction of the movable platen 120 at the time of mold opening (for example, an X-axis negative direction) is defined as the rear.

The ejector device 200 is attached to the movable platen 120 and moves frontward and rearward together with the movable platen 120. The ejector device 200 includes an ejector rod 210 that ejects a molded article from the mold device 800, and a drive mechanism 220 that moves the ejector rod 210 in the moving direction (X-axis direction) of the movable platen 120.

The ejector rod 210 is disposed in a through-hole of the movable platen 120 so as to be movable frontward and rearward. The front end portion of the ejector rod 210 is in contact with the ejector plate 826 of the movable mold 820. The front end of the ejector rod 210 may be connected to the ejector plate 826 or need not be connected to the ejector plate 826.

The drive mechanism 220 includes, for example, an ejector motor and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs the ejection process under the control of the control device 700. In the ejection step, the ejector rod 210 is advanced from the standby position to the ejection position at a set moving speed, whereby the ejector plate 826 is advanced and the molded article is ejected. Thereafter, the ejector motor is driven to retract the ejector rod 210 at a set moving speed, and the ejector plate 826 is retracted to the original standby position.

The position and the moving speed of the ejector rod 210 are detected by using, for example, an ejector motor encoder. The ejector motor encoder detects a rotation of the ejector motor and sends a signal indicating the detection result to the control device 700. The ejector rod position detector for detecting the position of the ejector rod 210 and the ejector rod moving speed detector for detecting the moving speed of the ejector rod 210 are not limited to the ejector motor encoder, and general detectors can be used.

### Injection Device

In the descriptions of the injection device 300, unlike the descriptions of the mold clamping device 100 and the descriptions of the ejector device 200, a moving direction of the screw 330 at the time of filling (for example, the X-axis negative direction) is defined as the front, and a moving direction of the screw 330 at the time of metering (for example, the X-axis positive direction) is defined as the rear.

The injection device 300 is installed on a slide base 301, and the slide base 301 is disposed so as to be movable frontward and rearward with respect to an injection device frame 920. The injection device 300 is disposed so as to be movable frontward and rearward with respect to the mold device 800. The injection device 300 touches the mold device 800 and fills the cavity space 801 in the mold device 800 with a molding material. The injection device 300 includes, for example, a cylinder 310 that heats a molding material, a nozzle 320 provided at a front end portion of the cylinder 310, a screw 330 disposed in the cylinder 310 so as to be movable frontward and rearward and rotatable, a metering motor 340 that rotates the screw 330, an injection motor 350 that moves the screw 330 frontward and rearward, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312, such as a water-cooled cylinder or the like, is provided on the outer periphery of the rear portion of the cylinder 310. A first heater 313, such as a band heater or the like, and a first temperature detector 314 are provided on the outer periphery of the cylinder 310 in front of the cooler 312.

The cylinder 310 is divided into a plurality of zones in the axial direction (for example, the X-axis direction) of the cylinder 310. The first heater 313 and the first temperature detector 314 are provided in each of the plurality of zones. A set temperature is set for each of the zones, and the control device 700 controls the first heater 313 so that the temperature detected by the first temperature detector 314 reaches the set temperature.

The nozzle 320 is provided at the front end portion of the cylinder 310 and is pressed against the mold device 800. A second heater 323 and a second temperature detector 324 are provided on the outer periphery of the nozzle 320. The control device 700 controls the second heater 323 so that the temperature detected by the nozzle 320 reaches the set temperature.

The screw 330 is disposed in the cylinder 310 so as to be rotatable and movable frontward and rearward. As the screw 330 is rotated, a molding material is pushed frontward along the spiral groove of the screw 330. The molding material is gradually melted by the heat from the cylinder 310 while being pushed frontward. As the liquid molding material is pushed to the front of the screw 330 and accumulated in the front portion of the cylinder 310, the screw 330 is retracted. Thereafter, as the screw 330 is advanced, the liquid molding material accumulated in front of the screw 330 is injected from the nozzle 320 and is filled into the mold device 800.

A backflow prevention ring 331 is attached to the front portion of the screw 330 so as to be movable frontward and rearward as a backflow prevention valve that prevents backflow of a molding material from the front to the rear of the screw 330 at the time of pushing the screw 330 frontward.

When the screw 330 is advanced, the backflow prevention ring 331 is pushed rearward by the pressure of the molding material in front of the screw 330, and is retracted relative to the screw 330 to a closure position (see FIG. 2) at which the backflow prevention ring 331 closes the flow path of the molding material. This prevents the molding material accumulated in front of the screw 330 from flowing rearward.

On the other hand, when the screw 330 is rotated, the backflow prevention ring 331 is pushed frontward by the pressure of the molding material pushed frontward along the spiral groove of the screw 330, and is advanced relative to the screw 330 to a release position (see FIG. 1) at which the backflow prevention ring 331 opens the flow path of the molding material. Thus, the molding material is pushed to the front of the screw 330.

The backflow prevention ring 331 may be either a co-rotation type that rotates together with the screw 330 or a non-co-rotation type that does not rotate together with the screw 330.

The injection device 300 may include a drive source that moves the backflow prevention ring 331 frontward and rearward between the release position and the closure position with respect to the screw 330.

The metering motor 340 rotates the screw 330. The drive source for rotating the screw 330 is not limited to the metering motor 340, and may be, for example, a hydraulic pump.

The injection motor 350 moves the screw 330 frontward and rearward. A motion conversion mechanism or the like for converting a rotational motion of the injection motor 350 into a linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source for advancing and retracting the screw 330 is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and a molding material, and is used for controlling or monitoring a pressure received by the screw 330 from a molding material, a back pressure to the screw 330, a pressure acting on a molding material from the screw 330, and the like.

A pressure detector for detecting the pressure of a molding material is not limited to the load detector 360, and a general pressure detector can be used. For example, a nozzle pressure sensor or a mold internal pressure sensor may be used. The nozzle pressure sensor is installed at the nozzle 320. The mold internal pressure sensor is installed inside the mold device 800.

The injection device 300 performs a metering step, a filling step, a hold pressure step, and the like under the control of the control device 700. The filling step and the hold pressure step may be collectively referred to as an “injection step”.

In the metering step, the metering motor 340 is driven to rotate the screw 330 at a set rotation speed, and the molding material is pushed frontward along the spiral groove of the screw 330. As a result, the molding material is gradually melted. As the liquid molding material is pushed to the front of the screw 330 and accumulated in the front portion of the cylinder 310, the screw 330 is retracted. The rotation speed of the screw 330 is detected by using, for example, the metering motor encoder 341. The metering motor encoder 341 detects the rotation of the metering motor 340 and sends a signal indicating the detection result to the control device 700. A screw rotational speed detector for detecting the rotational speed of the screw 330 is not limited to the metering motor encoder 341, and a general detector can be used.

In the metering step, in order to suppress a rapid retreat of the screw 330, the injection motor 350 may be driven to apply a set back pressure to the screw 330. The back pressure to the screw 330 is detected by using, for example, the load detector 360. When the screw 330 is retracted to a metering completion position and a predetermined amount of the molding material is accumulated in front of the screw 330, the metering step is completed.

A position and a rotation speed of the screw 330 for the metering step are collectively set as a series of set conditions. For example, a metering start position, a rotational speed switchover position, and a metering completion position are set. These positions are arranged in this order from the front to the rear, and represent the start point and the end point of a section for which a rotation speed is set. A rotation speed is set for each section. The number of a rotation speed switchover position may be one or more. A rotation speed switchover position need not be set. A back pressure is set for each section.

In the filling step, the injection motor 350 is driven to move the screw 330 frontward at a set moving speed, and a liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350 and sends a signal indicating the detection result to the control device 700. When the position of the screw 330 reaches a set position, changeover from the filling step to the hold pressure step (so-called V/P switchover) is performed. The position where the V/P switchover is performed is also referred to as a “V/P switchover position”. A set moving speed of the screw 330 may be changed according to the position of the screw 330, time, or the like.

A position and a moving speed of the screw 330 for the filling step are collectively set as a series of set conditions. For example, a filling start position (also referred to as an “injection start position”), a moving speed switchover position, and a V/P switchover position are set. These positions are arranged in this order from the rear to the front, and represent the start point and the end point of a section for which a rotation speed is set. A moving speed is set for each section. The number of a moving speed switchover position may be one or more. A moving speed switchover position need not be set.

An upper limit value of the pressure of the screw 330 is set for each section for which a moving speed of the screw 330 is set. The pressure of the screw 330 is detected by the load detector 360. In the case where the pressure of the screw 330 is equal to or lower than the set pressure, the screw 330 is moved frontward at the set moving speed. On the other hand, in the case where the pressure of the screw 330 exceeds the set pressure, for the purpose of protecting the mold, the screw 330 is advanced at a moving speed lower than the set moving speed so that the pressure of the screw 330 becomes equal to or lower than the set pressure.

Note that, after the position of the screw 330 reaches the V/P switchover position in the filling step, the screw 330 may be temporarily stopped at the V/P switchover position, and then V/P switchover may be performed. Immediately before V/P switchover, the screw 330 may be advanced or retracted at a very low speed instead of stopping the screw 330. A screw position detector for detecting the position of the screw 330 and a screw moving speed detector for detecting the moving speed of the screw 330 are not limited to the injection motor encoder 351, and general detectors can be used.

In the hold pressure step, the injection motor 350 is driven to push the screw 330 frontward, and the pressure of a molding material at the front end portion of the screw 330 (hereinafter, also referred to as a “held pressure”) is remained at the set pressure, and the molding material remaining in the cylinder 310 is pushed toward the mold device 800. The molding material can be thus replenished by the shortage due to cooling shrinkage in the mold device 800. The held pressure is detected by using, for example, the load detector 360. The set value of the held pressure may be changed according to a length of time elapsed from the start of the hold pressure step. A plurality of held pressures and durations during which a held pressure is maintained in the hold pressure step may be set, and may be collectively set as a series of set conditions.

In the hold pressure step, a molding material in the cavity space 801 in the mold device 800 is gradually cooled, and when the hold pressure step is completed, the inlet of the cavity space 801 is closed by the solidified molding material. This state is called a “gate seal”, and a backflow of the molding material from the cavity space 801 is prevented. After the hold pressure step, the cooling step is started. In the cooling step, the molding material in the cavity space 801 is solidified. In order to shorten a molding cycle time, a metering step may be performed during the cooling step.

The injection device 300 of the present embodiment is of an inline screw type but may be of a pre-plasticization type. A pre-plasticizing injection device supplies a molding material melted in a plasticizing cylinder to an injection cylinder, and injects the molding material from the injection cylinder into a mold device. In the plasticizing cylinder, a screw is disposed rotatably and unmovably frontward and rearward, or a screw is disposed rotatably and movably frontward and rearward. On the other hand, a plunger is disposed in the injection cylinder so as to be movable frontward and rearward.

The injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the vertical injection device 300 may be a vertical type or a horizontal type.

### Moving Device

In the descriptions of the moving device 400, similarly to the descriptions of the injection device 300, a moving direction of the screw 330 at the time of filling (for example, the X-axis negative direction) is defined as the front, and a moving direction of the screw 330 at the time of metering (for example, the X-axis positive direction) is defined as the rear.

The moving device 400 advances and retracts the injection device 300 with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 has a first port 411 and a second port 412. The hydraulic pump 410 is a pump capable of rotating in both directions, and generates a hydraulic pressure by switching the rotation direction of the motor 420 to suck a working liquid (for example, oil) from either of the first port 411 and the second port 412 and discharge the liquid from the other. The hydraulic pump 410 can also suck a working liquid from the tank and discharge the working liquid from either of the first port 411 and the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder main body 431, a piston 432, and a piston rod 433. The cylinder main body 431 is fixed to the injection device 300. The piston 432 divides the interior of the cylinder main body 431 into a front chamber 435 as a first chamber and a rear chamber 436 as a second chamber. The piston rod 433 is fixed relative to the stationary platen 110.

The front chamber 435 of the hydraulic cylinder 430 is connected to the first port 411 of the hydraulic pump 410 via a first flow path 401. The working liquid discharged from the first port 411 is supplied to the front chamber 435 via the first flow path 401, and thus the injection device 300 is pushed frontward. The injection device 300 is advanced, and the nozzle 320 is pressed against the stationary mold 810. The front chamber 435 functions as a pressure chamber that generates a nozzle touch pressure of the nozzle 320 by the pressure of the working liquid supplied from the hydraulic pump 410.

The rear chamber 436 of the hydraulic cylinder 430 is connected to the second port 412 of the hydraulic pump 410 via a second flow path 402. The working liquid discharged from the second port 412 is supplied to the rear chamber 436 of the hydraulic cylinder 430 via the second flow path 402, and thus the injection device 300 is pushed rearward. The injection device 300 is retracted, and the nozzle 320 is separated from the stationary mold 810.

In the present embodiment, the moving device 400 includes the hydraulic cylinder 430, but the present invention is not limited to this example. For example, instead of the hydraulic cylinder 430, an electric motor and a motion conversion mechanism that converts the rotational motion of the electric motor into the linear motion of the injection device 300 may be used.

### Control Device

The control device 700 is configured by, for example, a computer, and includes a central processing unit (CPU) 701, a storage medium 702 such as a memory, an input interface 703, and an output interface 704 as illustrated in FIGS. 1 and 2. The control device 700 performs various controls by causing the CPU 701 to execute programs stored in the storage medium 702. The control device 700 receives a signal from an external device through the input interface 703 and transmits a signal to an external device through the output interface 704.

The control device 700 includes an electronic circuit such as a CPU, a graphics processing unit (GPU), a field programmable gate array (FPGA), or an application specific integrated circuit (ASIC), and executes various control operations described in the specification of the present application by executing an instruction code stored in a memory or by being circuit-designed for a special purpose.

The control device 700 repeatedly performs the metering step, the mold closing step, the pressure increasing step, the mold clamping step, the filling step, the hold pressure step, the cooling step, the pressure releasing step, the mold opening step, the ejection step, and the like, thereby repeatedly manufacturing a molded product. A series of operations for obtaining a molded article, for example, an operation from the start of the metering step to the start of the next metering step is also referred to as a “shot” or a “molding cycle”. A time required for one shot is referred to as a “molding cycle time” or a “cycle time”.

One molding cycle includes, for example, a metering step, a mold closing step, a pressure increasing step, a mold clamping step, a filling step, a hold pressure step, a cooling step, a pressure releasing step, a mold opening step, and an ejection step in this order. The order here is the order of the start of each step. The filling step, the hold pressure step, and the cooling step are performed during the mold clamping step. The start of the mold clamping step may coincide with the start of the filling step. The completion of the pressure releasing step coincides with the start of the mold opening step.

In order to shorten a molding cycle time, a plurality of steps may be performed at the same time. For example, the metering step may be performed during the cooling step of the previous molding cycle, or may be performed during the mold clamping step. In this case, the mold closing step may be performed at the beginning of the molding cycle. The filling step may be started during the mold closing step. The ejection step may be started during the mold opening step. In the case where an opening/closing valve that opens and closes the flow path of the nozzle 320 is provided, the mold opening process may be started during the metering process. This is because even if the mold opening step is started during the metering step, a molding material does not leak from the nozzle 320 as long as the opening/closing valve closes the flow path of the nozzle 320.

One molding cycle may include a step other than the metering step, the mold closing step, the pressure increasing step, the mold clamping step, the filling step, the hold pressure step, the cooling step, the pressure releasing step, the mold opening step, and the ejection step.

For example, after the completion of the hold pressure step, before the start of the metering step, a pre-metering suck back process of retracting the screw 330 to a predetermined metering start position may be performed. This reduces the pressure of a molding material accumulated in front of the screw 330 before the start of the metering step, and a rapid retreat of the screw 330 at the start of the metering process can be thereby prevented.

After the completion of the metering step yet before the start of the filling step, a post-metering suck back step may be performed after the metering to retract the screw 330 to a preset filling start position (also referred to as an “injection start position”). This reduces the pressure of a molding material accumulated in front of the screw 330 before the start of the filling step, and a leakage of the molding material from the nozzle 320 before the start of the filling step can be thereby prevented.

The control device 700 is connected to an operation device 750 that receives an input operation by a user and a display device 760 on which a screen is displayed. The operation device 750 and the display device 760 may be configured by, for example, a touch panel 770 and may be integrated. The touch panel 770 as the display device 760 is caused to display a screen under the control of the control device 700. For example, information, such as setting of the injection molding machine 10 and a current state of the injection molding machine 10, may be displayed on the screen of the touch panel 770. On the screen of the touch panel 770, an operation unit, such as a button or an input field for receiving an input operation by a user, may be displayed, for example. The touch panel 770 as the operation device 750 detects an input operation on the screen by a user and outputs a signal corresponding to the input operation to the control device 700. Thus, for example, a user can perform setting (including input of a set value) of the injection molding machine 10 by operating the operation unit provided on the screen while checking information displayed on the screen. A user's operation of the operation unit provided on the screen can cause the injection molding machine 10 to perform an operation corresponding to the operation. The operation of the injection molding machine 10 may be, for example, an operation (including stopping) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided separately. A plurality of operation devices 750 may be provided. The operation device 750 and the display device 760 are disposed on the operation side (Y-axis negative direction) of the mold clamping device 100 (more specifically, the stationary platen 110).

### Details of Mold Clamping Device

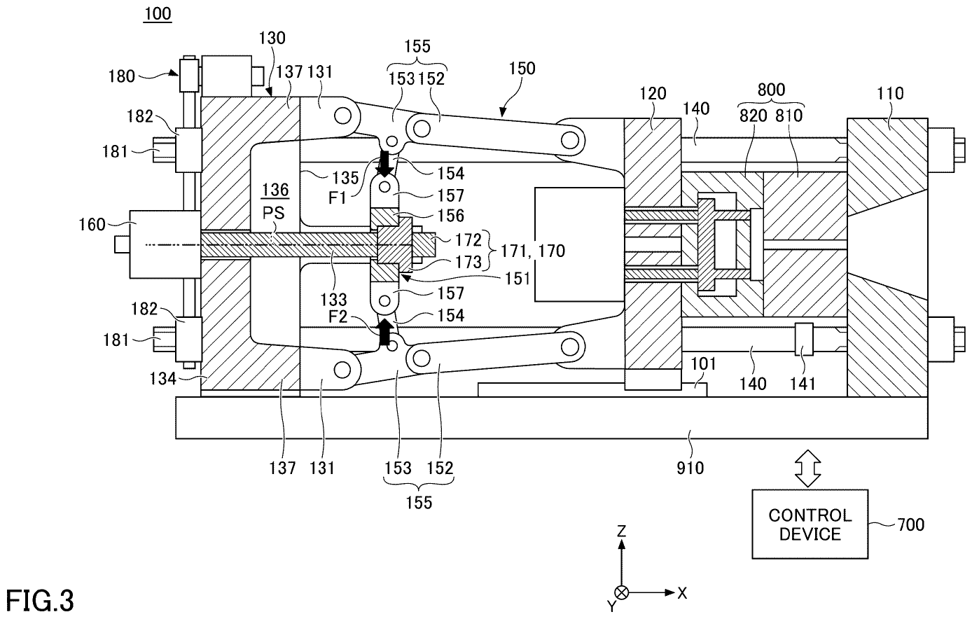

An example in which the technology of the present disclosure is applied to the mold clamping device 100 will be described with reference to FIGS. 3 through 6 in addition to FIGS. 1 and 2. The technique of the present disclosure is applicable to any device having a toggle mechanism and a ball screw, and is applicable to, for example, the ejector device 200. The ejector device 200 may include a ball screw that converts a rotational motion of an ejector motor into a linear motion of a crosshead, and a toggle mechanism that includes a link group that is bent and extended in accordance with the crosshead moving frontward and rearward.

The mold clamping device 100 includes a ball screw 171 as illustrated in FIGS. 3 through 5. The ball screw 171 is the motion conversion mechanism 170, and converts a rotational motion of the mold clamping motor 160 into a linear motion of the crosshead 151. The ball screw 171 includes a ball screw shaft 172 and a ball screw nut 173. The mold clamping motor 160 rotates the ball screw shaft 172, thereby moving the ball screw nut 173 frontward and rearward. The ball screw nut 173 is fixed to the crosshead 151.

The mold clamping device 100 includes the toggle mechanism 150. The toggle mechanism 150 includes the crosshead 151 and a link group 155 that is bent and extended in accordance with the crosshead 151 moving frontward and rearward. The crosshead 151 moves frontward and rearward together with the ball screw nut 173. The link group 155 includes the first link 152 and the second link 153. A pair of link groups 155 may be provided symmetrically, with the ball screw 171 interposed between the link groups 155.

The two (pair) link groups 155 are provided with an interval therebetween in the first direction, with the ball screw 171 interposed between the link groups 155. In the case where the mold clamping device 100 is a horizontal type, the first direction is the Z-axis direction. The Z-axis direction includes a Z-axis positive direction (upward direction) and a Z-axis negative direction (downward direction). In the case where the mold clamping device 100 is a horizontal type, the pair of link groups 155 is disposed in a vertically symmetric manner with respect to the ball screw 171. The mold clamping device 100 may be a vertical type.

The toggle mechanism 150 amplifies a driving force of the mold clamping motor 160 and transmits the amplified driving force to the movable platen 120. The first link 152 is swingably attached to the movable platen 120 by a pin or the like. The second link 153 is swingably attached to the toggle support 130 by a pin or the like. The second link 153 is attached to the crosshead 151 via a third link 154.

The toggle support 130 has an attachment portion 131 to which the link group 155 is attached. The attachment portion 131 swingably supports the second link 153 via a pin. The attachment portion 131 has a plurality of attachment plates provided at intervals in the axial direction of the pin. Each of the attachment plates is formed with a through hole penetrating the attachment plate, and the pin is inserted through the through hole. A pair of attachment portions 131 may be provided symmetrically, with the ball screw 171 interposed between the attachment portions 131.

The two (pair) attachment portions 131 are provided with an interval therebetween in the first direction, with the ball screw 171 interposed between the attachment portions 131, similarly to the pair of link groups 155. In the case where the mold clamping device 100 is a horizontal type, the first direction is the Z-axis direction. In the case where the mold clamping device 100 is a horizontal type, the pair of attachment portions 131 is disposed in a vertically symmetric manner with respect to the ball screw 171. The mold clamping device 100 may be a vertical type.

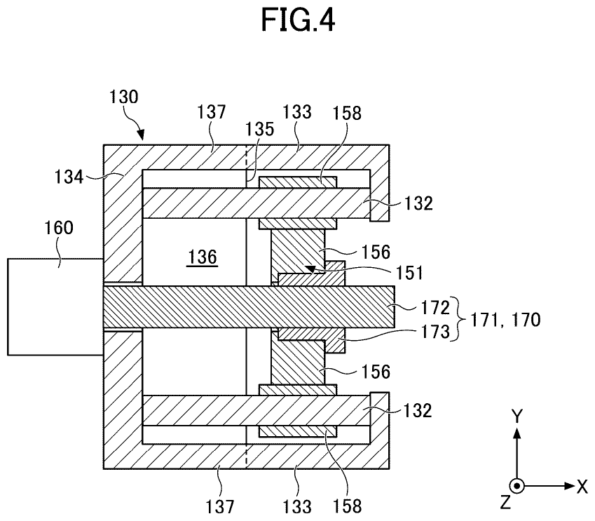

As illustrated in FIG. 4, the toggle support 130 includes a guide 132 that guides the crosshead 151, an arm 133 that supports the guide 132, and a platen 134 on which the attachment portion 131 and the arm 133 are provided. The attachment portion 131 and the arm 133 are provided on one surface 135 of the platen 134. The attachment portion 131, the arm 133, and the platen 134 may be integrally formed by casting or the like.

The one surface 135 of the platen 134 may be perpendicular to the second direction, which is the direction in which the crosshead 151 moves frontward and rearward. In the case where the mold clamping device 100 is a horizontal type, the second direction is the X-axis direction. The X-axis direction includes an X-axis positive direction (frontward direction) and an X-axis negative direction (rearward direction). The mold clamping device 100 may be a vertical type.

A recess 136 is formed in the one surface 135 of the platen 134. The recess 136 can accommodate at least a part of the crosshead 151 when the mold is opened. The dimension of the mold clamping device 100 in the front-rear direction can be therefore shortened, and the mold clamping device 100 can be downsized. The attachment portion 131 and the arm 133 are provided on a frame portion 137 surrounding the recess 136.

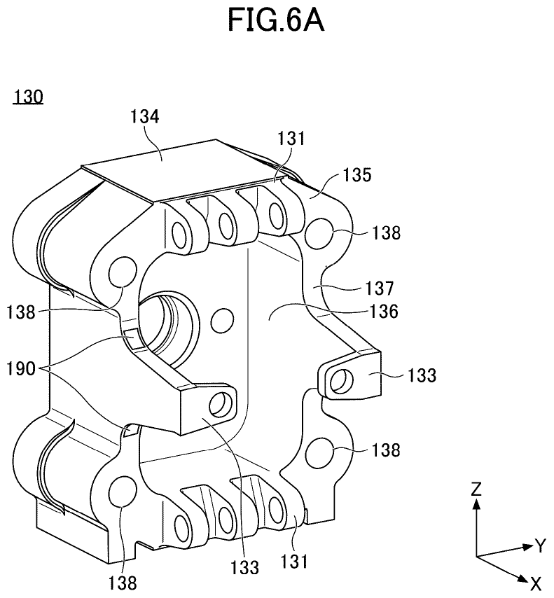

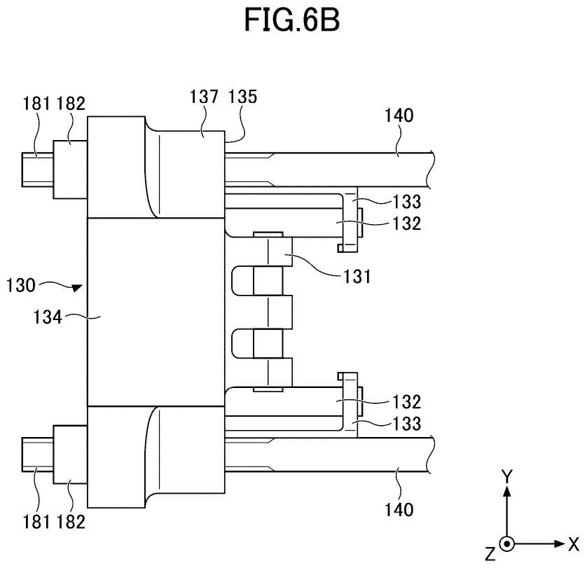

As illustrated in FIG. 6A, the frame portion 137 has a substantially rectangular shape when viewed in the second direction (e.g., the X-axis direction), for example. A through hole 138 is formed in each of four corners of the frame portion 137 as seen in the second direction. The through hole 138 penetrates the platen 134 in the second direction. The tie bar 140 is inserted into the through hole 138. As illustrated in FIG. 6B, the screw shaft 181 is formed at the rear end of the tie bar 140, and the screw nut 182 is screwed onto the screw shaft 181. The tie bar 140 is fixed to the platen 134 via the screw nut 182 or the like.

As illustrated in FIG. 4, the guide 132 guides the crosshead 151 in the second direction (for example, the X-axis direction). The crosshead 151 is provided with a through hole penetrating the crosshead 151 in the second direction. The guide 132 is inserted into the through hole. The guide 132 has, for example, a columnar shape. A pair of the guides 132 may be provided symmetrically, with the ball screw 171 interposed between the guides 132.

As illustrated in FIGS. 3 to 5, the crosshead 151 includes a nut fixing portion 156, a link attachment portion 157, and a guide insertion portion 158. The ball screw nut 173 is fixed to the nut fixing portion 156. A pair of link attachment portions 157 is provided, with the nut fixing portion 156 interposed between the link attachment portions 157 in the first direction (for example, the Z-axis direction). The third link 154 is swingably attached to each link attachment portion 157. A pair of guide insertion portions 158 is provided, with the nut fixing portion 156 interposed between the guide insertion portions 158 in the third direction (for example, the Y-axis direction). Each guide insertion portion 158 is provided with a through hole, and the guide 132 is inserted into the through hole.

As illustrated in FIG. 4, the two (pair) guides 132 are provided with an interval therebetween in the third direction, with the ball screw 171 interposed between the guides 132. The third direction is a direction perpendicular to the first direction and the second direction. In the case where the mold clamping device 100 is a horizontal type, the third direction is the Y-axis direction. The Y-axis direction includes a Y-axis positive direction (counter-operation direction) and a Y-axis negative direction (operation direction). In the case where the mold clamping device 100 is a horizontal type, the pair of guides 132 is disposed symmetrically, with the ball screw 171 interposed between the guides 132. The mold clamping device 100 may be a vertical type.

The arm 133 is provided on the one surface 135 of the platen 134, protrudes frontward, is bent in the middle, and the tip end portion of the arm 133 holds the front end portion of the guide 132. The rear end portion of the guide 132 is fixed to the platen 134. In the case where the recess 136 is formed in the one surface 135 of the platen 134, the rear end portion of the guide 132 is fixed to the inner bottom surface of the recess 136. A pair of the arms 133 may be provided symmetrically, with the ball screw 171 interposed between the arms 133.

The two (pair) arms 133 are provided with an interval therebetween in the third direction (for example, the Y-axis direction), with the ball screw 171 interposed between the arms 133, similarly to the pair of guides 132. In the case where the mold clamping device 100 is a horizontal type, the pair of arms 133 are disposed symmetrically, with the ball screw 171 interposed between the arms 133. The mold clamping device 100 may be a vertical type.

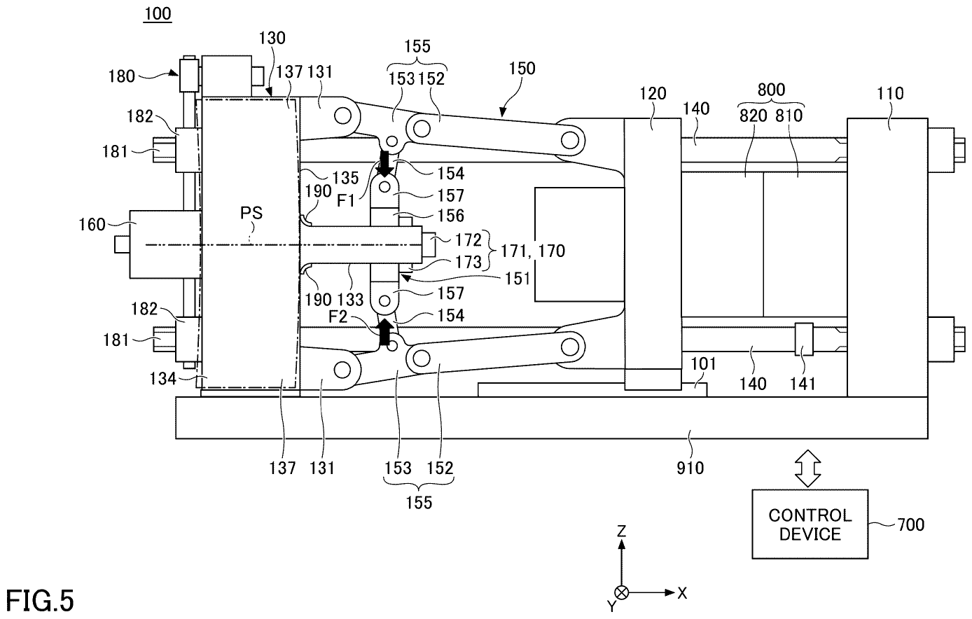

As illustrated in FIG. 5, during mold clamping, loads F1 and F2 are applied to the crosshead 151 from both sides of the first direction (for example, the Z-axis direction). When a balance of the toggle mechanism 150 is lost and a difference between the load F1 on one side and the load F2 on the opposite side occurs, an unbalanced load is applied to the ball screw 171. As a result, uneven wear of the ball screw 171 may develop.

Therefore, the mold clamping device 100 is provided with a strain gauge 190. The strain gauge 190 is attached to the toggle support 130 and detects a strain of the toggle support 130. The strain gauge 190 is attached to the toggle support 130 with an adhesive, a magnet, or the like. The method of attaching the strain gauge 190 is not particularly limited.

The toggle support 130 is deformed during mold clamping as illustrated by the chain line in FIG. 5. The deformation of the toggle support 130 represents a balance of the toggle mechanism 150. In the case where there is no difference between the load F1 on one side and the load F2 on the opposite side, the toggle support 130 is deformed symmetrically with respect to the ball screw 171. In the case where a difference between the load F1 on one side and the load F2 on the opposite side occurs, the toggle support 130 is deformed asymmetrically with respect to the ball screw 171.

The deformation of the toggle support 130 varies according to a balance of the toggle mechanism 150, and the detection value of the strain gauge 190 consequently changes. The control device 700 can thus detect an unbalanced load on the ball screw 171 based on the detection value of the strain gauge 190. The toggle support 130 is not moved or rotated by the mold opening and closing, unlike the crosshead 151 and the link group 155. It is therefore easy to route the wiring of the strain gauge 190.

The control device 700 detects an unbalanced load on the ball screw 171 by detecting that a difference between a detection value of the strain gauge 190 and a reference value exceeds a threshold value, for example. The larger the mold clamping force, the larger the deformation of the toggle support 130. Therefore, the reference value may be set according to the mold clamping force. The larger the mold clamping force is, the larger the reference value is set to be.

As illustrated in FIG. 5 and FIG. 6A, it is preferable that the strain gauge 190 be attached to the arm 133 or the one surface 135 of the platen 134. This is because the arm 133 or the one surface 135 of the platen 134 is relatively close to the toggle mechanism 150 and is easily affected by the change in the balance of the toggle mechanism 150.

It is preferable that the strain gauge 190 be disposed at a position away from the reference plane PS. The reference plane PS is a virtual plane on which the rotation center line of the ball screw 171, the pair of guides 132, and the pair of arms 133 lie. In the case where the mold clamping device 100 is a horizontal type, the reference plane PS is a horizontal plane. The pair of attachment portions 131 is disposed, with the reference plane PS interposed between the attachment portions 131. The pair of attachment portions 131 is disposed plane-symmetrically with respect to the reference plane PS.

In the case where there is no difference between the load F1 on one side and the load F2 on the opposite side, the toggle support 130 deforms plane-symmetrically with respect to the reference plane PS of the pair of link groups 155. By disposing the strain gauge 190 at a position away from the reference plane PS, it is easy to detect a change in deformation of the toggle support 130 and consequently detect an unbalanced load on the ball screw 171.

It is preferable that the strain gauge 190 be provided on each of one side and the other side of the reference plane PS. In this example, as illustrated in FIG. 5, the strain gauges 190 are disposed at the proximal end of the arm 133 respectively on the upper side and the lower side of the reference plane PS, being separated from the reference plane PS by several centimeters. In this case, the control device 700 can detect an unbalanced load on the ball screw 171 by using a detection value of one strain gauge 190 and a detection value of the other strain gauge 190. In this example, an unbalanced load is detected based on whether or not a difference between the detection value of one strain gauge 190 and the detection value of the other strain gauge 190 exceeds a threshold value. In other words, in this example, the detection value of the other strain gauge 190 is used as a reference value. However, it is also possible to determine an occurrence of an unbalanced load based on a balance between the two detection values or amplitude of the two detection values, without calculation using the difference or the threshold value.

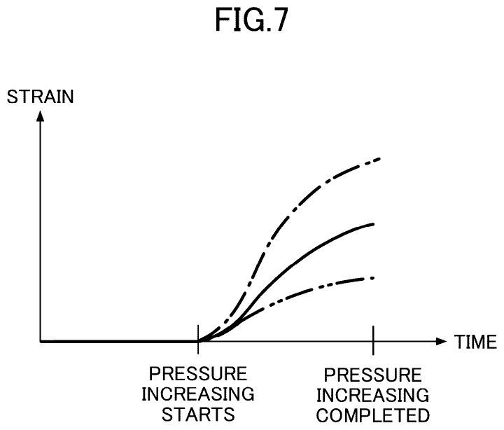

FIG. 7 is a graph illustrating an example of the detection value of the strain gauge 190. In FIG. 7, the horizontal axis represents time, and the vertical axis represents the strain of the toggle support 130. The solid line indicates the detection value of the strain gauge 190 in the case where there is no difference between the load F1 on the upper side and the load F2 on the lower side. The chain line indicates the detection value of the strain gauge 190 on the upper side of the reference plane PS in the case where the load F1 on the upper side is larger than the load F2 on the lower side. The two-dot chain line indicates the detection value of the strain gauge 190 on the lower side of the reference plane PS in the case where the load F1 on the upper side is larger than the load F2 on the lower side.

As illustrated in FIG. 7, the waveform of the detection value of the strain gauge 190 is different between the case where there is no difference between the load F1 on the upper side and the load F2 on the lower side and the case where there is a difference between the load F1 and the load F2. Therefore, the control device 700 can detect an unbalanced load on the ball screw 171. The control device 700 can detect uneven wear of the ball screw 171 based on a magnitude of an unbalanced load on the ball screw 171 and a length of time during which the unbalanced load is applied. Furthermore, the control device 700 can predict the mechanical life of the ball screw 171 and perform control to issue an alarm for prompting replacement of the ball screw 171.

The strain gauge 190 is attached to the arm 133, more preferably in the vicinity of the one surface 135 of the platen 134. This is because the toggle support 130 is deformed during mold clamping as illustrated by the chain line in FIG. 5, and the load is concentrated on the proximal end of the arm 133. The proximal end of the arm 133 has a curved surface to mitigate stress concentration. It is preferable that the strain gauge 190 be attached to the curved surface.

In the present embodiment, the strain gauges 190 are respectively attached to the upper surface and the lower surface of the single arm 133, in other words, one side and the other side of the reference plane PS. However, the strain gauges 190 may be respectively provided on one side and the opposite side with respect to a second reference plane. The second reference plane is a virtual plane including the rotation center line of the ball screw 171 and the pair of attachment portions 131. In the case where the mold clamping device 100 is a horizontal type, the second reference plane is a vertical plane. Specifically, the strain gauges 190 may be respectively attached to each of the arms 133 of a pair. In this case, a balance between the left and right of the toggle mechanism 150 can be detected. The number of the strain gauges 190 attached to each arm 133 is not particularly limited.

The embodiment of the injection molding machine and the injection molding machine according to the present invention have been described above, but the present invention is not limited to the above-described embodiments and the like. Various changes, modifications, substitutions, additions, deletions, and combinations can be made within the scope of the claims. Such modifications are also included in the technical scope of the present invention.

What is claimed is:

1. An injection molding machine, comprising:
a ball screw configured to convert a rotational motion of a motor into a linear motion of a crosshead;
a toggle mechanism including the crosshead and a pair of link groups that are bent and extended by the crosshead moving frontward and rearward;
a toggle support including a pair of attachment portions to which the link groups of the pair of link groups are respectively attached; and
a strain gauge configured to detect a strain of the toggle support, wherein
the toggle support includes
a pair of guides configured to guide the crosshead;
a pair of arms configured to support the pair of guides; and
a platen having one surface on which the pair of attachment portions and the pair of arms are provided,
the pair of attachment portions are provided, with a reference plane interposed between the attachment portions, the reference plane being a virtual plane on which a rotation center line of the ball screw, the pair of guides, and the pair of arms lie, and
the strain gauge is attached to one or both of the pair of arms or the one surface of the platen.

2. The injection molding machine according to claim 1, wherein
the strain gauge is disposed at a position away from the reference plane.

3. The injection molding machine according to claim 2, wherein
the strain gauge is disposed on each of one side and an opposite side with respect to the reference plane.

4. The injection molding machine according to claim 1, wherein
the strain gauge is attached to one or both of the pair of arms and is attached in the vicinity of the one surface of the platen.

5. The injection molding machine according to claim 1, further comprising
a control device configured to detect an unbalanced load on the ball screw based on a detection value of the strain gauge.
